(19) United States
(12) Patent Application Publication
(10) Pub. No.: US 2007/0251888 A1
(43) Pub. Date: Nov. 1, 2007

(54) Method and Apparatus for Feeding Chemical Into a Liquid Flow

(75) Inventor: Jouni Matula, Savonlinna (FI)

Correspondence Address: NIXON & VANDERHYE, PC, 901 NORTH GLEBE ROAD, 11TH FLOOR, ARLINGTON, VA, 22203, US

(73) Assignee: WETEND TECHNOLOGIES OY, Savonlinna (FI)

(21) Appl. No.: 11/572,174

(22) PCT Filed: Jul. 8, 2005
(86) PCT No.: PCT/FI05/00322

§ 371 Date: May 11, 2007

(30) Foreign Application Priority Data
Jul. 15, 2004 (FI) FI 20040986

(51) Int. Cl. C02F 1/68; B01F 3/04

(52) U.S. Cl. 210/752; 210/220

(57) ABSTRACT

A method of feeding chemical to a liquid flowing in an open space, the method including: feeding the chemical to the liquid by at least one special mixing device; introducing a feed liquid to the at least one special mixing device separately from the chemical; contacting the chemical and the feed liquid together essentially simultaneously with the discharge of the chemical and the feed liquid through a nozzle opening of the mixing device, wherein the nozzle opening is located under a surface of the liquid flowing into the open space.

The present invention relates to a method and apparatus for feeding chemical into a liquid flow. The method and the apparatus of the invention are particularly well applicable when chemical must be fed to a liquid in an open space or to liquid flowing in an open space. An advantageous application worth mentioning is an open space in a paper machine environment, such as a wire pit, a wire chute, filtrate water duct or a corresponding member into which for example antifoaming chemical is fed.

Naturally, there is practically an innumerable amount of prior art methods of feeding various chemicals into liquid flows. These methods may, however, be divided into a few main categories, as seen from the following. Firstly, it is quite possible to let the liquid to be added flow freely into a second liquid without employing any special regulation or mixing means. This kind of an adding method cannot be used in situations where the mixing ratio or mixing uniformity are of importance. Neither can it be employed in a situation where the price of the chemical to be added is of significance. The next applicable method is to feed the chemical in a strict proportion to the liquid flow, whereby correct and economical proportioning is obtained. However, even in this case one has to take into account that usually the chemical dose is slightly excessive compared to the optimal dosage, because the mixing is known to be inadequate. However, the mixing may be improved by feeding the chemical e.g. through a perforated wall of a flow channel, whereby the chemical to be mixed may at least be spread throughout the liquid flow. Lastly, a situation may be discussed, where the chemical is fed in a strict proportion either into the liquid flow uptream of the mixer or via the mixer itself into the liquid. In that case, the efficiency of the mixing of the chemical into the liquid flow is totally dependent on the mixer design.

FI patent no. 108802 discusses as an essential case of mixing relating to paper manufacture the mixing of a retention aid into fiber suspension flowing to the headbox of a paper machine. In the paper manufacture, retention chemicals are used especially in order to improve the retention of fines at the wire section of a paper machine. In the FI patent mentioned the mixing device is in fact a conical nozzle with a connection for the retention chemical. The mixing device is practical and efficient in mixing both retention aid and other chemicals in the short circulation of a paper machine and other applications in the pulp and paper industry. In some applications it has been observed, however, that various solid materials carried by the feed and/or dilution liquid tend to accumulate in the apparatus. In other words, such parts of the apparatus that converge in the flow direction, tend to collect solid material, which gradually disturbs the flow profile, the flow itself and in the end tend to clog the device. FI patent application no. 20021350 discloses a feed nozzle which is self-cleaning. In other words when the nozzle tends to be clogged its flow conditions change and the nozzle reacts to the change by opening wider the cross-sectional flow area of the flow duct in which the suspension carrying the solids flows whereby the solid particles caught in the duct can get loose from the nozzle and can continue to flow on.

In this kind of applications, i.e. in feeding for example retention chemicals into a fiber suspension, the mixing devices and nozzles of the publications mentioned work well but in cases where the volume of the chemical needed is very small compared with the suspension flow to be fed, the nozzles discussed are not the best possible as far as their operation is concerned for example because they cannot provide an adequately homogenous distribution of the chemical into the process liquid flow because of the small volume of the chemical.

Among other things in order to solve the problem described above, Finnish patent application no. 20031488 discloses a new type of a chemical feed device the structure of which is very favourable in feeding small chemical amounts to a liquid flow. The feed device of the publication mentioned contains a rather thin tubular pipe preferably located inside a feed apparatus/nozzle so that the desired volume of chemical, in this case as small a volume as possible, can be mixed homogenously to the process liquid flow. The tubular pipe feeding the chemical feeds the chemical to a special nozzle portion of the feeding device which preferably is designed to have a kind of an isolated mixing space, where the chemical and the mixing liquid to be fed to the feeding device through a connection of its own are mixed, and from which they are, after they have been mixed, fed through openings in the mixing space first to the feed liquid and after that by means of the feed liquid to the process liquid. Mixing of the chemical and diluting it to a mixture of chemical and liquid prior to feeding it to the process liquid flow duct ensures homogenous mixing of the chemical to the process liquid. This is why the volume of the chemical to be fed to the feeding device can be even less than on the order of one and a half per cent of the liquids to be supplied to the feed device, which are the mixing liquid and the feed liquid feeding the mixing liquid and the chemicals to the liquid flow. Several feeding devices of the publication in question instead of one can be provided if needed in connection with the process liquid flow duct.

The structure of feed device of the Finnish publication in question, more specifically expressed the isolated mixing space at the end of the feed duct, improves the mixing of the chemicals also in another way. When the liquid chemical hits the wall of the isolated mixing space it “disperses” uniformly to the whole interior of the isolated mixing space of the mixer and becomes diluted and mixed to the mixing liquid more homogenously. In addition to this structure the feed device may contain a kind of an additional counterpart which, placed at the center of the mouth of the tubular duct feeding the chemical, further improves the mixing to the other liquid to be fed and further to the liquid flow to be fed.

Chemical may be fed to the feed device described above without a separate dilution, in other words the dilution of the chemical takes place in the particular isolated mixing space of the feed device by means of the mixing liquid. This solution dispenses with the need of a separate dilution tank, reduces the fresh water consumption and thus decreases operation and maintenance costs. On the other hand, the chemical may be diluted also before it is fed to the feeding device if desired.

The feed device mentioned can be used also in the feeding of, among other things, chemicals, such a for example antifoaming agents, TiO2, optical brighteners, paper dyes, and silicates, to the flowing process liquid, only to mention a few chemicals. The feed device is thus applicable in all processes where these chemicals must be fed, in particular when the chemical volume is small compared with the total volume of the flowing suspension flow. As advantageous examples of the processes, among other fiber suspension flows of paper mills, thickening processes of various sludges, recycling fiber processes and bleaching processes may be mentioned, and in general processes where it is necessary to feed chemical, particularly in very small amounts to a filtrate, fiber suspension, sludge or a corresponding medium.

In the mixing device mentioned, the feed liquid by means of which a chemical is supplied to the process liquid, for example a fiber suspension, can be the same fiber suspension into which the chemical is to be fed. Of course also more dilute suspensions, various filtrates or corresponding media, or mere fresh water are suitable for use as the feed liquid in the apparatus of the publication. The mixing liquid can also be either a liquid obtained from the process itself or fresh water.

Thus all the liquid obtained from another process stage that can be used in the feeding of the chemical at the same time saves fresh water and reduces for example the fresh water consumption of the mills. All the applications of the various mixing apparatus mentioned above have, however, dealth with adding of chemical to a pressurized liquid flowing in a duct. On the other hand, adding chemical to a liquid in an open vessel or flowing in an open duct has for long been known to be problematic. Examples of this kind of problem points are a wire pit of a paper machine, a wire spout or a secondary liquid duct or a filtrate duct used either in the paper industry or elsewhere, for example antifoaming agent or a chemical used in the treatment of the liquids mentioned being dosed into all of these most commonly by allowing the chemical to flow slowly from a thin pipe to the surface of the liquid in the wire pit, the duct or the channel whereby the mixing depends on the turbulence of the flow, alone. As the flow velocities in this kind of open spaces or channels are in most cases relatively low the turbulence of the flow is very weak and thus the mixing takes a long time and also requires a long flow distance. Further it should be noted that the use of flow barriers, which in some closed duct flows are used with the intention to create turbulence, is rather futile, on one hand because of the very low flow velocities and on the other hand often large flow volumes.

When a mixer according to any of the publications mentioned above was installed in a location of this kind and the need of an antifoaming agent was considered, it was noticed that the apparatus in question could mix the antifoaming agent so efficiently to the liquid that the antifoaming agent dose could be reduced about to a half. In a test performed the dose could be reduced even by 60% of the one used earlier.

In other words it is characteristic of the method and apparatus of the present invention for feeding chemical to a liquid in an open space or flowing in an open space that the chemical mentioned is fed to the liquid by means of a special mixing device or several special mixing devices by means of feed liquid introduced to the mixing device separately from the chemical by allowing the chemical and the feed liquid to discharge essentially simultaneously through the mixing device nozzle opening located under the liquid surface in the space to the liquid in the space or flowing in the space.

The characterizing features of the method and the apparatus of the invention are disclosed by the appended patent claims.

In the following, the method and the apparatus according to the invention are described in more detail with reference to the appended figures, where

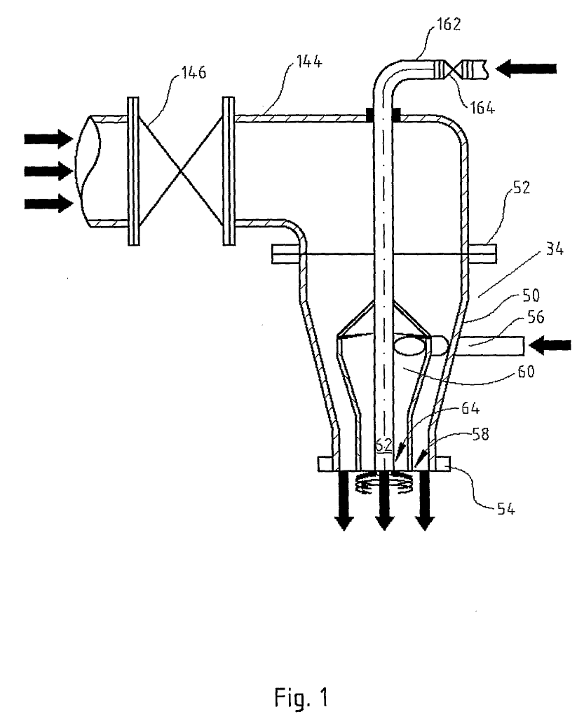

FIG. 1 illustrates a prior art chemical feeding device;

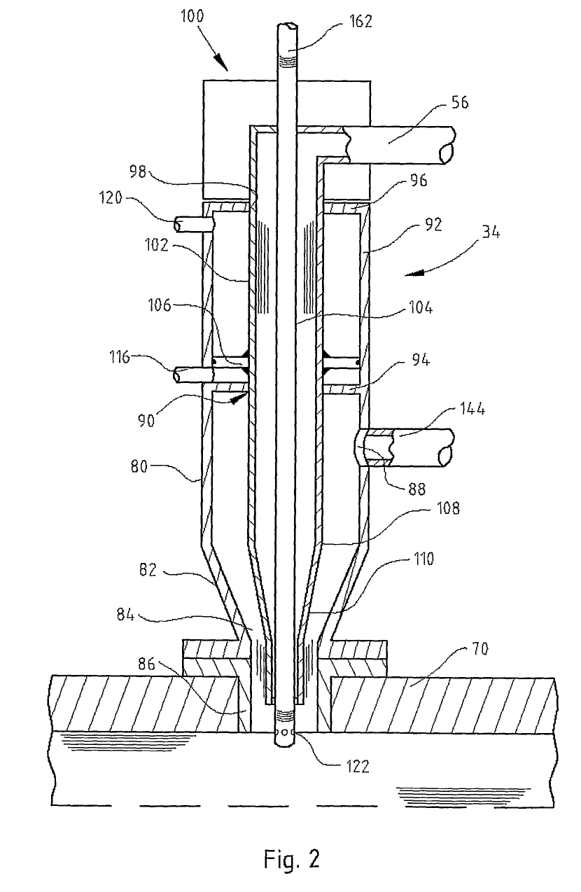

FIG. 2 illustrates another prior art chemical feeding device; and

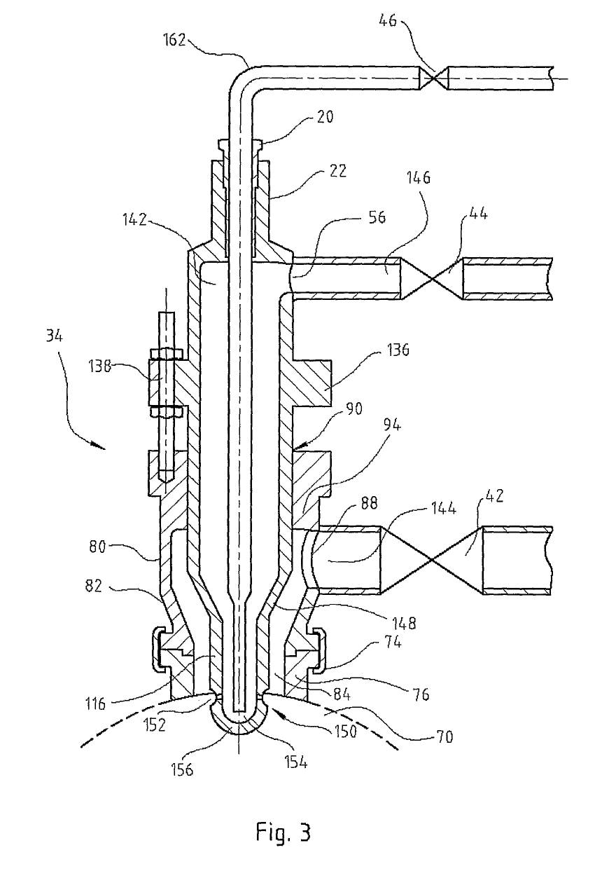

FIG. 3 illustrates a third prior art chemical feeding device;

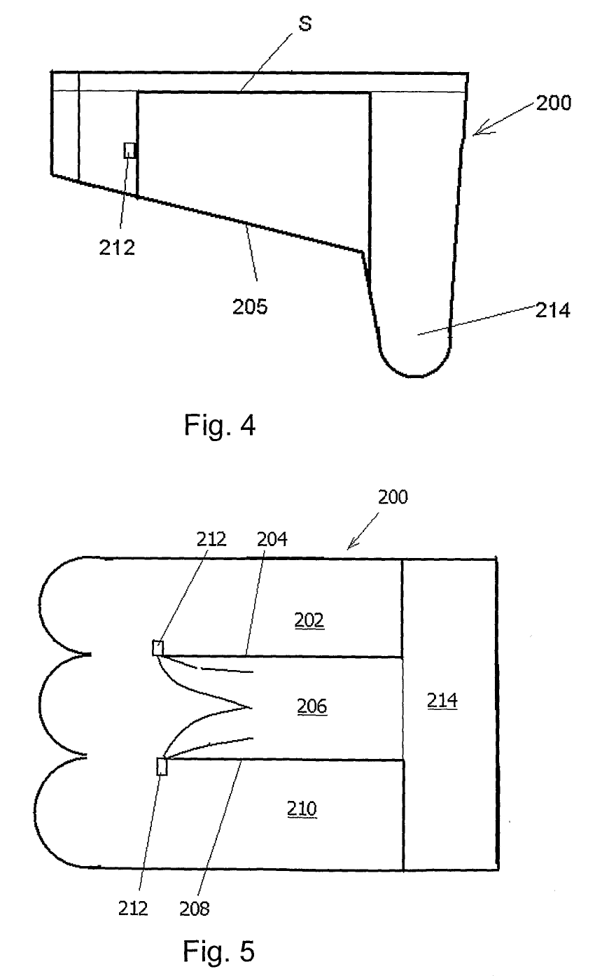

FIG. 4 illustrates an arrangement according to a first preferred embodiment of the invention for feeding chemical to the wire pit of a paper machine

FIG. 5 illustrates the arrangement of FIG. 4 seen from above; and

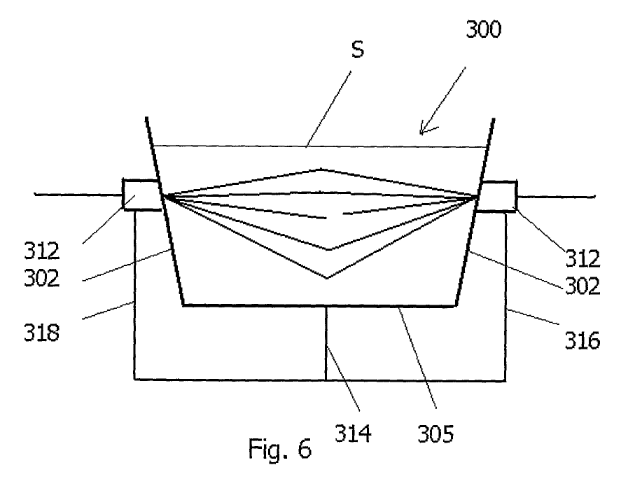

FIG. 6 illustrates an arrangement according to another preferred embodiment of the invention for feeding chemical to a liquid flowing in a duct.

FIG. 1 illustrates schematically the mixing apparatus of a preferred embodiment of FI patent no. 108802. The mixing apparatus 34 according to FIG. 1 is, in fact, a nozzle comprising preferably an essentially conical casing 50, flanges 52 and 54 arranged into it and preferably, but not necessarily, placed at its opposite ends, and a conduit 56 for the retention chemical. The mixing apparatus 34 is connected via the flange 52 to a dilution medium pipe and via the flange 54 to a fiber suspension flow duct. In the arrangement according to the figure, the casing 50 of the mixing apparatus 34 is converging from the flange 52 towards the flange 54 inside of which the opening 58 of the mixing apparatus is located. A purpose of the conical form of the casing 50 is to accelerate the medium flow in the mixing apparatus 34 so that the velocity of the jet discharging from the mixing apparatus 34 into the fiber suspension flow is at least five times the velocity of the fiber suspension flow. In the embodiment according to figure, the retention chemical feeding conduit 56 is preferably tangential in order to ensure that retention aid discharging through the opening 58 of the mixing apparatus 34 into the fiber suspension flow is distributed homogeneously at least on the whole periphery of the opening 58. Inside the mixing apparatus 34 there is a centrally disposed hollow member 60 into which the retention chemical is supplied via the conduit 56. In other words, the conduit 56 pierces the conical wall 50 of the mixing apparatus 34 and further leads via the annular space between the cone 50 and the member 60 into the member 60, at the same time preferably carrying the member 60 in its place. The member 60 is pierced axially by hole 62 to which mixing liquid in introduced via a valve 164 and a duct 162; thus the liquid is discharged from inside the chemical flow to the fiber suspension flow duct. The retention aid flow guided tangentially inside the member 60 turns in the form of a spiral flow towards the opening 58 of the mixing device, where the retention aid has (according to the figure) at the lower end of the member 60 an annular opening 64 of its own, through which the retention aid is discharged as a fan-shaped jet into the fiber suspension together with the feed liquid discharging from outside the opening 64 and the mixing liquid discharging through the hole 62 from inside the opening 64. The figure clearly shows that the retention aid is not in any contact with the mixing liquid before it is discharged through the opening 64 into the fiber suspension flow duct.

FIG. 2 illustrates another prior art feed nozzle 34. It comprises, starting from below, i.e. from the liquid flow duct 70, a substantially cylindrical nozzle casing 80 having a conical reduction 82 provided at the end facing the fiber suspension flow duct. The reduction ends at a centrally located feed opening 84 which continues towards the flow duct 70 in members 86 for securing the feed nozzle 34 to the liquid flow duct 70. An opening 88 has been provided in the side wall of the nozzle casing 80, preferably in its cylindrical portion, which communicates with a feed liquid conduit 144 for introduction of feed liquid to the mixing nozzle 34. The end of the nozzle casing 80 opposite the flow duct 70 has been provided with both a round central opening 90 and a pressure medium cylinder 92 serving as a continuation of the nozzle casing 80, the other end of which is formed by an end 94 of the nozzle casing opposite the flow duct. In the opposite end of the pressure medium cylinder 92, there is an end plate 96 having a central round opening 98 like the upper end of the nozzle casing 80.

The nozzle casing 80 extends from above through both the openings 98 and 90 of the ends 96 and 94 mentioned above of the mixing liquid feed apparatus 100. These feed apparatus include for example a chemical feed duct 142, which has a flow connection with the chemical feed conduit 56, and a mixing liquid feed duct 104, which in turn communicates with a mixing liquid feed conduit 162, which in this embodiment is located centrally inside a chemical feed duct 102, the feed ducts 102 and 104 being connected at their upper ends to each other. The chemical feed duct 102 is preferably cylindrical along most of its length as it at the same time serves in this embodiment as the piston rod of the pressure medium cylinder 92. The piston itself is a piston disc 106 secured at the outer surface of the chemical feed duct 102 and sealed in relative to the pressure medium cylinder 92. It is natural that both the ends 94 and 96 of the pressure medium cylinder 92 have been provided with a suitable sealing in order to ensure the operation of the cylinder.

The chemical feed duct 102 has been provided at its lower end, in other words the end located at the fiber suspension flow duct 70 inside the nozzle casing, with a conical reduction 108, which is located essentially at the cone 82 of the nozzle casing 80 and the extent of conicality of which is on the same order as that of the conical reduction 82 of the nozzle casing 80. The mixing liquid feed duct 104 in turn runs centrally inside the chemical feed duct 102 and extends to a distance outside the conical reduction 108 of the chemical feed duct 102. The figure illustrates how the chemical feed duct 102 continues as a cylindrical nozzle duct 110 after the conical reduction 108 in such a way that a narrow slot is formed between the mixing liquid feed duct 104 and the wall of the nozzle duct 110, where the velocity of the chemical is increased to a level suitable for introduction to the fiber suspension flow.

In the normal state the feed nozzle is in the operating position illustrated in FIG. 2, whereby both the nozzle duct 110 of the chemical feed duct 102 and the mixing liquid feed duct 104 are located outside the nozzle casing 80 essentially at the level of the fiber suspension flow duct wall. In the flushing position the pressure medium led to the pressure medium cylinder 92 through an opening 116 pushes by means of the piston disc 106 the chemical and the mixing liquid feed apparatus 100 upwards so that the distance between the cones 82 and 108 increases and the end 118 of the miring liquid feed duct 104 rises so high that the feed liquid flow flushes all impurities or solid matter from between the cones through the opening 84 to the fiber suspension flow duct. After a certain time, the flushing time is preferably about 1-6 seconds, pressure medium is guided through an opening 120 at the opposite end of the pressure medium cylinder 92 to the cylinder whereby the disc 106 presses the chemical and mixing liquid feed apparatus 100 back to the operation position. The function described above is guided either by the feed liquid pressure, the pressure difference or the volume flow.

FIG. 3 illustrates a preferred embodiment of a feed apparatus, i.e. the feed nozzle 34, disclosed in FI patent application 20031468. It comprises, starting from below, i.e. from the liquid flow duct 70, a substantially cylindrical nozzle casing 80 having a conical reduction 82 provided at the end facing the liquid flow duct. The reduction 82 ends at a centrally located feed opening 84 which continues towards the flow duct 70 in members 74 and 76 for securing the feed nozzle 34 to the liquid flow duct 70. An opening 88 has been provided in the side wall of the nozzle casing 80 preferably in its cylindrical portion, which communicates through a conduit 144 and a valve 42 with the feed liquid inlet duct for introductino of feed liquid to the mixing nozzle 34.

The mixing liquid feed duct 142 forms with the chemical feed duct 162 the cylindrical upper portion of the feeding apparatus 34. Both the feed ducts, 142 and 162, continue also inside the nozzle casing 80 up to the liquid flow duct 70. The position of the end of the feed duct is adjustable in relation to the liquid flow duct 70 so that the end of the duct extends preferably inside the flow duct. The end of the nozzle casing 80 opposite the flow duct 70 has been provided with an end 94 and that with a round central opening 90 for the mixing liquid feed duct 142. At the upper section formed by the feed duct 142 there is provided a flange 136 and a movable screw/nut connection 138 or a corresponding member by means of which the upper section (the feed duct 142) and the lower section (nozzle casing 80) of the feeding device 34 are attached to each other

In addition to securing the upper and the lower sections to each other by these members, 136 and 138, the adjustable screw 138 may be used to adjust the position of the mixing liquid feed duct 142 of the feeding apparatus 34 and the chemical feed duct 162 in relation to the flow duct 70. The adjustability of the feeding apparatus 34 and the structure of the securing members 74 and 76 allow the use of the feeding apparatus 34, in other words engaging it, in process liquid flow ducts 70 of very different thicknesses.

In the side wall of the feed duct 142, preferably in its cylindrical portion, at a location outside the ends 94 and 136, the nozzle casing 80 and the feed liquid feed opening 88 as seen from the flow duct 70, there is an opening 56 for the mixing liquid to be fed to the feeding apparatus 34 In the embodiment, the feed opening 56 preferably communicates via the mixing liquid feed duct 146, which is tangential in relation to the feeding apparatus 34, and via the adjustable valve 44 with the mixing liquid feed duct in order to introduce mixing liquid to the feeding apparatus 34.

The chemical feed duct 162, which is preferably a thin tubular member for feeding small chemical volumes, extends in this embodiment to the feeding apparatus 34 from above. Also in this embodiment the feed duct 162 has been bent above the feeding apparatus 34 to the same direction as the feed and mixing liquid ducts 144 and 146. The amount of chemical to be fed can be controlled for example by means of the valve 46 located in the chemical feed duct 162. The chemical feed duct 162 has been secured to an elongated outer end 22 of the feeding apparatus 34 by a securing means 20. The feed duct 162 communicates in this embodiment with the mixing liquid feed duct 142 by being located centrally inside the mixing liquid feed duct 142 where it continues close to a particular nozzle means 150 of the feed duct 142, the nozzle part in turn being adjustable to extend inside the process liquid flow duct 70.

In this embodiment, the chemical feed duct 142 has been provided at its lower end, in other words the end located at the fiber suspension flow duct 70 inside the nozzle casing, with a conical reduction 148, which is located essentially at the cone 82 of the nozzle casing 80 and the extend of its conicality is on the same order as that of the conical reduction 82 of the nozzle casing 80. The conical reduction 148 of the mixing liquid feed duct 412 does not extend quite to the lower edge of the feed liquid reduction 82 but the feed duct continues as a cylindrical duct 116 inside the feed opening 84; thus the cross-sectional flow area between these members is reduced in the flow direction and further increases the velocity of the feed liquid. The flow velocity of the mixture of chemical and feed liquid to be fed to the process liquid in the process liquid flow duct 70 is at the feeding moment at least fivefold compares with the flow velocity of the process liquid flow

The cylindrical duct 116 of the lower section of the mixing liquid feed duct 142 ends in the nozzle means 150, which forms a mixing space 154 isolated from the feeding liquid and the flowing process liquid and is needed for the mixing of the chemical, and from which the chemical (a mixture of chemical and mixing liquid) is at first fed via openings 152 to the feed liquid flow and from there at an even rate with the feed liquid further to the liquid flow duct 70. The isolated mixing space 154 in the nozzle means 150 is formed for example by the cup-like “closed” end 156 of the mixing liquid flow duct 142 and the openings 152 at its sides. The openings 152 have been provided in the wall above the mixing space 154 of the nozzle means 150. The mixing liquid and the chemicals mixed to it are discharged through the openings 152 practically in the form of a radical fan to the feed liquid. The openings 152 may be round, angular or for example slot-like in form, only to mention a few examples. The tubular thin chemical feed duct 162 extends to the end 156 of the nozzle means 150, preferably past the openings 152. This embodiment guarantees a good mixing of chemical as the chemical jet hits the end of the nozzle means 150 and is distributed from there evenly to the whole mixing liquid volume and further via openings 152 to the liquid flow duct 70. Thus, the mixing and dilution of the chemical takes place before the chemical is introduced with the feed liquid to the process liquid. This ensures that precise amounts of chemical are mixed to the entire process liquid flow area. According to another preferred embodiments, if desired, a kind of an additional counterpart having the form of for example a cone has been provided at the end of the chemical feed duct 162 quite in the center of it, which disperses the chemical jet when it hits it, and the mixing takes place even more efficiently. Another alternative is to provide such an end cup 156 of the duct 142 that its form causes the chemical flow coming from the duct 162 to be distributed homogenously to different sides of the duct 162 for example by disposing at the bottom of the end cup in a central position in relation to the duct 162 a conical or a corresponding protrusion tapering towards the duct.

Preferably the nozzle means 150 of the mixing liquid flow duct 142 and the mixing space 154 in it are located inside the process liquid flow duct 70 or at least in the immediate vicinity of the inner surface of the flow duct 70 mentioned so that the mixing of the chemical to the mixing liquid takes place at the most 0.5 seconds before the chemical is mixed to the process liquid. Compared with the situation illustrated by FIG. 3, where the openings 152 are located just inside the wall of the process liquid flow duct 70 (illustrated schematically), the openings 152 can also be located at the annular feed opening 84 of the feed liquid, in other words inside the duct portion 76.

The purpose of the feed liquid dish discharging from the opening 84 of the feed apparatus 34 is to give the chemical jet the required velocity which feeds the chemical efficiently to the whole flow area of the liquid flow duct 70. The feed liquid hits mainly in an axial direction the chemical jet discharging from openings 152 almost radially, giving the chemical speed and improving the mixing to the process liquid flowing in the flow duct 70. The direction and the penetration of the chemical jet can be controlled as desired by adjusting the feeding apparatus 34 by means of the screw 138 and the feed pressure by means of the valves 42, 44 and 46.

FIGS. 4 and 5 illustrate an arrangement according to a preferred embodiment of the invention for feeding chemical to a liquid in an open space or flowing in an open space. In this context an open space means a space where the liquid has a surface defined by the atmosphere or a corresponding gas space. As an example of such a space, a paper machine wire pit 200 as seen from the side (FIG. 4) and from above (FIG. 5) has been illustrated. FIGS. 4 and 5 illustrate a wire pit type, which has recently become popular, as an example of a wire pit, only, without any intention to limit the invention to concern the presented wire pit type, only. Firstly, the wire pit 200 illustrated operates so that water is filtered to it through the wire of the paper machine or water is guided to it from different dewatering units of the paper machine via ducts and/or channels. The wire pit 200 illustrated in the figure has a three-chamber structure so that the chambers 202, 206 and 210 are defined by both the outer walls of the wire pit 200 including the inclined bottom 205 and the intermediate walls 204 and 208 extending to the level of the liquid surface S of the wire pit. In the embodiment of the figure the chambers 202 and 210 are further defined by an intermediate wall separating the chamber space from the spout 214, the wall also extending to the level of the liquid surface S. In fact the intermediate walls 204 and 208 of the chambers can be considered to have the form of an L. The idea is that the liquid filtered or directed to the wire pit is taken mainly along the chamber 206 in the middle to the chute 214 at the other end of wire pit and the water is removed from there by pumping. The purpose of the wire pit in general is to give the gas dissolved or otherwise mixed in the liquid during paper manufacture time to be separated from the liquid so that the gas in the liquid would not disturb pumping of the liquid after the wire pit or other measures the liquid is subjected to. In order to promote the separation of the gas, antifoaming agent is usually mixed, if that term can be used, to the liquid so that the agent is allowed to flow at a rate of on the order of 0.5-5 l/min, onto the surface of the liquid in the wire pit without any agitating means. The amount to be dosed depends for example on the size of the paper machine in question and the paper grade to be manufactured. The antifoaming agent reduces the surface tension of the liquid whereby the gas in the liquid can more easily be separated into bubbles and the bubbles in turn can grow faster so that they also rise to the surface of the liquid faster and exit the liquid.

Now, according to the present invention the antifoaming agent is dosed by means of the mixing devices 212 disposed in connection with the intermediate walls 204 and 208 to the liquid flowing to the chamber 206 in the middle whereby the antifoaming chemical is quickly and homogenously mixed to the liquid in the wire pit 200. Mixing devices may be provided also in connection with the walls of the wire pit or bottom, in addition to the location in connection with the intermediate walls. The main aspect is that the feed of the chemical takes place from the nozzle openings of the mixing devices to a location under the liquid surface in the wire pit (illustrated in FIG. 4 by line S) on one hand so that the chemical jet is distributed to a wide range in the liquid and on the other hand so that the surface of the liquid is not broken by the jet because breaking the surface could cause mixing of additional gas into the liquid. Preferably, although not necessarily, the chemical is fed in a perpendicular direction relative to the direction of movement of the liquid. The chemical can be fed as such, in other words in the composition it comes to the mill, or as a mixture separately manufactured at the mill, or the chemical can be diluted with a process liquid, preferably with the liquid in the wire pit itself.

FIG. 6 illustrates a method according to another preferred embodiment of the invention for feeding chemical to a liquid in an open space or flowing in an open space. The figure illustrates a liquid flow duct 300 which may be for example a wire chute, a secondary liquid channel, filtrate water channel or a corresponding liquid flow duct open to the atmosphere. In the embodiment illustrated in the figure, the chemical is fed from mixing devices 312 which are located on opposite sides of the duct 300 at the walls 302 of the duct so that the chemical jets cover an essential portion of the cross-sectional flow area of the duct 300. The same rules apply to the direction of the chemical jets as in the embodiment of FIGS. 4 and 5, in other words the entire jets must stay under the surface S of the flowing liquid.

FIG. 6 further illustrates schematically how a duct 314 has been connected to the bottom 305 of the duct for extracting from the duct 300 the liquid needed by the mixing devices 312, In the embodiment of the figure the duct 314 is divided in two branches 316 and 318 which take the liquid to the mixing devices 312. A pump (not illustrated) for feeding the liquid is preferably located either In connection with the duct 314 or at the location where the duct 314 is divided into ducts 316 and 318. Depending totally on the size of the duct 300 the duct wall can be provided with several mixing devices 312. If the duct is deep enough, mixing devices may be disposed also at the bottom of the duct as long as it can be ensured that the chemical jet discharging from the nozzle openings of the mixing devices does not reach the liquid surface or at least not through it. Only one mixing device 312 may be adequate in certain small ducts. In these cases, as also in the others, it is preferable to design the structure of the mixing device so that the jet discharging from it covers as well as possible the cross-sectional flow area to be treated

In the embodiments illustrated both in the FIGS. 4 and 5, and in the FIG. 6, the feeding device used is preferably the mixing device presented earlier in FIGS. 1-3, or a modification of it. In other words, the initial situation is that the chemical, whatever it may be, is ejected by means of a particular feeding liquid to a liquid flowing in a duct whereby the chemical penetrates by means of the jet to an essential portion of the cross-sectional area of the duct and thus the chemical is mixed to the liquid essentially more efficiently than by methods used before.

In addition to the antifoaming agent mentioned the method of the invention can be used also in feeding various other chemicals for treatment of filtrates or even waste water to a liquid in an open vessel. In the same way, also all other chemicals, no matter how large or small their volume in relation to the liquid to be treated is, can be fed using the method of the invention, as FIGS. 1-3 illustrate mixing apparatus suitable for chemical volumes of even very different size.

As can be seen from the above a new method and apparatus have been developed for mixing different chemicals into a liquid in an open tank or flowing in an open duct. However, only a few of the most preferred embodiments of the invention have been described above without any intention to limit the invention to for example the wood processing industry and/or waste water treatment. Thus, the field of application and the scope of protection of the invention are defined by the appended patent claims, only.

1. A method of feeding chemical to a liquid flowing in an open space, the method comprising:
feeding the chemical to the liquid through at least one special mixing device;
introducing a feed liquid to the at least one special mixing device separately from the chemical;
contacting the chemical and the feed liquid together essentially simultaneously with the discharge of the chemical and the feed liquid through a nozzle opening of the mixing device,
wherein the nozzle opening is located under a surface of the liquid flowing in the open space.

2. A method according to claim 1, wherein the feed liquid formed of at least one of the same liquid into which the chemical is fed, fresh water and another circulation liquid obtained from the process.

3. A method according to claim 1, wherein the chemical is mixed with a mixing liquid before the chemical is discharged with the feed liquid to the liquid flow.

4. A method according to claim 3, wherein the mixing liquid is formed of at least one of the same liquid into which the chemical is fed, fresh water and another circulation liquid obtained from the process.

5. A method according to claim 1, wherein the combined chemical feed liquid jet is guided under the surface of the liquid and the jet does not break the liquid surface.

6. A method according claim 1, wherein the chemical is mixed with a mixing liquid for less than 0.5 seconds before the mixture of chemical and mixing liquid is mixed with the liquid flow.

7. A method according to claim 1, wherein said chemical is at least one of an antifoaming agent, and a chemical for treatment of at least one of a filtrate, secondary liquid and waste water.

8. A method according claim 1 wherein said chemical and feed liquid are sprayed to the liquid essentially in a perpendicular direction in relation to a flow direction of the liquid.

9. An apparatus for feeding chemical to a liquid flowing in an open space, the apparatus comprising:
at least one mixing device,
a nozzle opening of the mixing device located under a surface (S) of the liquid or flowing in the space;
connections to said at least one mixing device, for at least said chemical and feeding liquid in which liquid the chemical is fed to said liquid, and
a first compartment in said at least one mixing device for said chemical and a second compartment in said at least one mixing device for said feeding liquid, and said first compartment and the second compartment each include a discharge at the nozzle opening, wherein the chemical and the feeding liquid are separate until discharged at the nozzle opening.

10. An apparatus according to claim 9, wherein said mixing device includes a connection for mixing a liquid with which the chemical is diluted.

11. An apparatus according to claim 9, further comprising a duct arrangement including at least one pump provided in said space for guiding the liquid flowing in the space to the mixing apparatus to serve as the feeding liquid in the mixing device.

12. An apparatus according to claim 9, wherein the open space is in one of a paper machine wire pit, a wire chute, a filtrate channel and a waste water duct.

13. A method to feed chemical to a liquid flowing in an open space, the method comprising:
feeding the chemical into a mixing device;
feeding a feed liquid into the mixing device separately from the feed of the chemical;
discharging the mixture of the chemical and the feed liquid substantially simultaneously through a nozzle opening of the mixing device, wherein the nozzle opening is under a surface of the liquid in the open space or in a flow of the liquid to the open space, and
first mixing the chemical and feed liquid substantially simultaneously with the discharge of the chemical and feed liquid through the nozzle opening.

14. A method as in claim 13 wherein the feed liquid is formed of at least one of the liquid into which the chemical is fed, fresh water and another circulation liquid obtained from the process.

15. A method according to claim 13 further comprising mixing the chemical with a mixing liquid in the mixing device and before the chemical is discharged with the feed liquid.

16. A method according claim 15 wherein the chemical is mixed with the mixing liquid for less than one-half of a second before discharging the chemical and mixing liquid.

17. A method according to claim 13, further comprising jetting the chemical and the feed liquid from the nozzle opening and into the liquid without breaking the surface of the liquid.

18. A method according to claim 13 wherein the chemical is at least one of an antifoaming agent and a chemical for treatment of at least one of filtrates, secondary liquids and waste waters.

19. A method according claim 13 wherein said chemical and the feed liquid are discharged in a direction perpendicular a flow direction of the liquid.

20. A mixing apparatus for feeding chemical to a liquid flowing in an open space, the apparatus comprising:
a first compartment to receive the chemical, wherein the first compartment has a discharge port of the chemical;
a second compartment to receive a feed liquid, wherein the first compartment is separated from the second compartment and the second compartment has a discharge port of the feed liquid;
a nozzle opening located under a surface of the liquid flowing in the space, and the discharge port for the first compartment and the discharge port for the second compartment are adjacent the nozzle opening,
wherein the chemical and feed liquid first mix and are discharged substantially simultaneously at the nozzle opening.

21. An apparatus according to claim 20 wherein said mixing apparatus includes a connection for mixing a liquid with which the chemical is diluted.

22. An apparatus according to claim 20 further comprising a duct including a pump in said space guiding the liquid in the flow of the patent in the space to the mixing apparatus to serve as the feeding liquid therein.

23. An apparatus according to claim 20 wherein the open space is in one of a paper machine wire pit, a wire chute, a filtrate channel and a waste water duct.
